(19) United States
(12) Patent Application Publication
(10) Pub. No.: US 2008/0294736 A1
(43) Pub. Date: Nov. 27, 2008

(54) Electronic Mail Identification System

(76) Inventor: John Shaw, Finchingfield (GB)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 12/121,366

(22) Filed: May 15, 2008

Related U.S. Application Data
(60) Provisional application No. 60/942,904, filed on Jun. 8, 2007.

(30) Foreign Application Priority Data
May 23, 2007 (GB) GB0709873.4

(51) Int. Cl. G06F 15/16; G06F 17/30

(52) U.S. Cl. 709/206; 707/5; 707/E17.015; 707/E17.032

(57) ABSTRACT

The present invention relates to an electronic mail identification system and methods, in particular to a system and methods for sending information corresponding to a keyword to an e-mail address of a user having a telecommunications device, said user registering with the system to indicate that the user solicits receiving said information. A method of sending information is provided to a keyword request from a user of an e-mail identification system to an e-mail address of said user, said user having a telecommunications device, said user not already registered with the system.

The present invention relates to an electronic mail identification system and methods, in particular to a system and methods for sending information corresponding to a keyword to an e-mail address of a user having a telecommunications device, said user registering with the system to indicate that the user solicits receiving said information.

An important example is a request to the database via sms/short-code or long code requesting data via keyword which will associate with information requested.

Historically, a major drawback to communicating by electronic mail is the increasing use of unsolicited e-mails or ‘spam’. For this reason many people do not like to give their personal email addresses to companies for fear of continuing unsolicited communications and or spam. This system introduces an additional buffer between the sending company and the recipient, which will enhance the exchange of information via email without compromising the user's confidentiality. In addition many users find it difficult to remember their e-mail addresses and mistakes are often made when conveying the address to a third party. This situation leads to email exchange being underused by the majority of the global population. This invention will encourage users to make use and realise the full potential of email. Generally only the Internet ‘savvy’ make use of email for information—with the email ID many more ‘high street’ users will be encouraged to use the power of email.

This invention will connect and enhance the power of sms and email and when combined the end result will be more than the sum of the original parts.

We will describe a device for a new email ID system that facilitates the easy storage of the email, the request and delivery of support and promotional email.

This system enables a retailer or advertiser to easily forward requested information to the recipient—which through personalisation can be forwarded to their personal online ‘mailbox’ or library whilst the server filters out unsolicited information. We will describe associating a mobile telephone/or land line phone with sms facilities directly to an email account.

We will describe associating an online email account with a unique user email ID that can be quickly communicated to a retailer or advertiser.

According to an aspect of the present invention, there is provided a method of sending information corresponding to a keyword to an e-mail address of a user of an e-mail identification system not already registered with the system, said user having a mobile telephone, or land line phone with sms facilities the method comprising: receiving a Short Message Service (SMS) message sent by said user to a short-code or long number using said mobile telephone, said SMS message including a keyword and a telephone and/or network code number of said mobile telephone; looking up said telephone number and/or network code in a database to determine whether said user is already registered with the system, and, if said user is not already registered: looking up said keyword and or network code in said database to determine whether said keyword is active, and, if said keyword is active: storing said telephone number and said keyword in said database for a predetermined length of time; sending an SMS message including information concerning how to register with the system to said telephone number; receiving, within said predetermined length of time, registration information comprising an e-mail address of said user sent by said user to a web server using a web browser, or sent by SMS to application and storing said e-mail address corresponding to said telephone number and network code in said database; retrieving keyword information corresponding to said keyword from said database; and sending an e-mail message including said keyword information to said e-mail address of said user.

In this specification, we describe mobile telephones being used with the system, but it will be understood by one skilled in the art that the user could also use a land line phone with SMS facilities. The SMS message may be sent to either a short-code or a normal (long) telephone number, the term “telephone number” being used to encompass both. The SMS message may include information on the user's telephone number and/or network code, which may identify the user's network provider. Any of this information may be stored in the database and used to identify the user. The SMS message may comprise a keyword, which may be letters, numbers or a combination of both. Other characters supported by Short Message Service may also be used.

Users may also register via the web interface of the system.

Email/electronic mail—means any email with attachment sent to email client in any shape or form. This may include TV mail or universal client mail.

According to another aspect of the present invention, there is provided a method of sending information corresponding to a keyword to an e-mail address of a user of an e-mail identification system already registered with the system, said user having a mobile telephone, the method comprising: receiving a Short Message Service (SMS) message sent by said user to a short-code or long number using said mobile telephone, said SMS message including a keyword and a telephone number and or network code of said mobile telephone; looking up said telephone number in a database to determine whether said user is already registered with the system, and, if said user is already registered: looking up said keyword in said database to determine whether said keyword is active, and, if said keyword is active: retrieving keyword information corresponding to said keyword from said database; retrieving an e-mail address of said user corresponding to said telephone number from said database; and sending an e-mail message including said keyword information to said e-mail address of said user.

The invention further provides processor control code to implement the above-described methods, for example on a general purpose computer system or on a digital signal processor (DSP). The code may be provided on a carrier such as a disk, CD- or DVD-ROM, programmed memory such as read-only memory (Firmware), or on a data carrier such as an optical or electrical signal carrier. Code (and/or data) to implement embodiments of the invention may comprise source, object or executable code in a conventional programming language (interpreted or compiled) such as C, or assembly code. The above described methods may also be implemented, for example, on an FPGA (field programmable gate array) or in an ASIC (application specific integrated circuit). Thus the code may also comprise code for setting up or controlling an ASIC or FPGA, or code for a hardware description language such as Verilog (Trade Mark), VHDL (Very high speed integrated circuit Hardware Description Language), or RTL code or SystemC. Typically dedicated hardware is described using code such as RTL (register transfer level code) or, at a higher level, using a language such as C. As the skilled person will appreciate such code and/or data may be distributed between a plurality of coupled components in communication with one another.

According to a further aspect of the present invention, there is provided an e-mail identification system for sending information corresponding to a keyword to an e-mail address of a user, said user having a mobile telephone, the system comprising: a database storing a plurality of keywords, keyword information corresponding to said plurality of keywords, a plurality of telephone numbers corresponding to a plurality of users, and or network code and a plurality of e-mail addresses corresponding to said plurality of users; a processor coupled to a communications interface for communicating with said database and with a mobile communications network, the processor being further coupled to a memory storing instructions for controlling the processor, when running, to carry out instructions to: receive, from said mobile communications network, a Short Message Service (SMS) message sent by said user to a short-code or long number using said mobile telephone, said SMS message including a keyword and a telephone number of said mobile telephone and or network code; look up said telephone number in a database to retrieve an e-mail address of said user corresponding to said telephone number; look up said keyword and said short-code or long number in said database to retrieve keyword information corresponding to said keyword; and send an e-mail message including said keyword information to said e-mail address of said user.

The system application may be written in any application programme language eg. Asp, php, .net, C++, Coldfusion etc.

Batch processing of SMS messages by SMS gateway and system application may be used to increase process speed and delivery of response SMS messages where appropriate and requested information by users email or other similar to be developed formats.

System application may be hosted on multiple servers to improve access and process times and reliability)

The invention also provides a token, plastic card, key fob, portable storage medium, standard debit or credit card, or loyalty card as set out in the independent claims.

Features of the above described aspects of the invention may be combined in any combination.

These and other aspects of the invention will now be described in further detail, with reference to the accompanying drawings, in which:

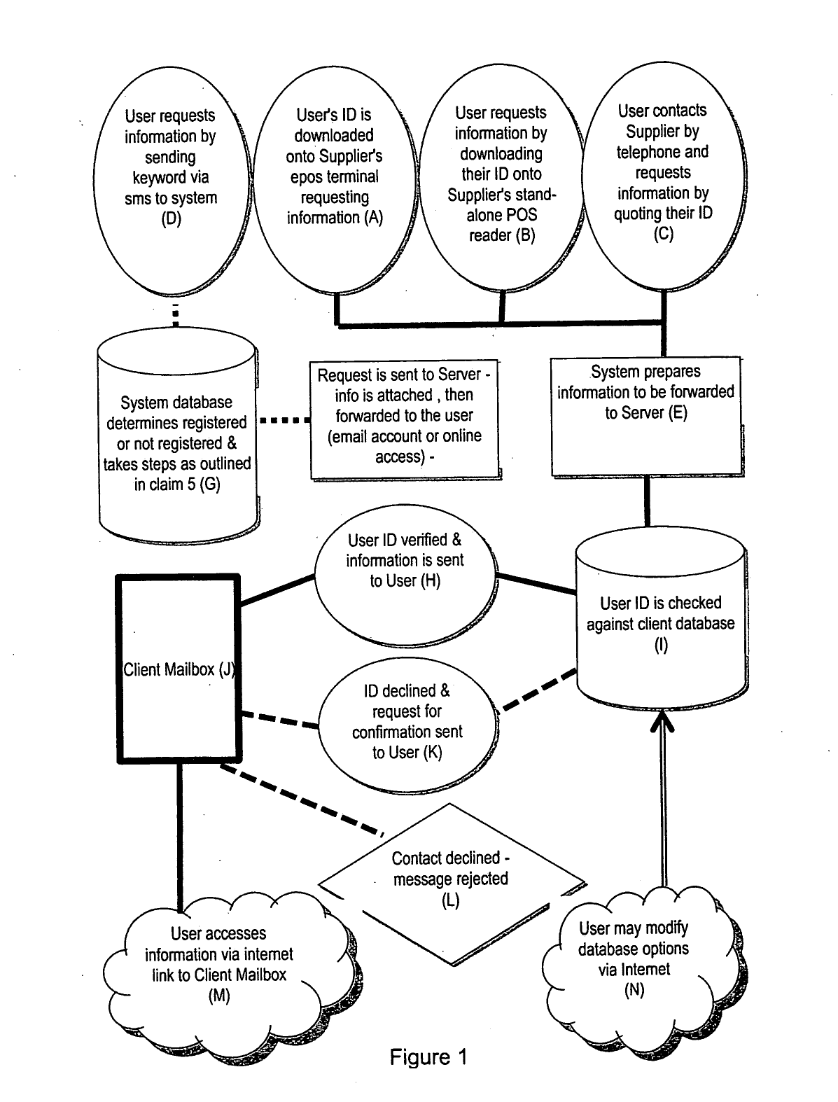

FIG. 1 shows an overall flowchart and block diagram of a method employed by a system according to the present invention.

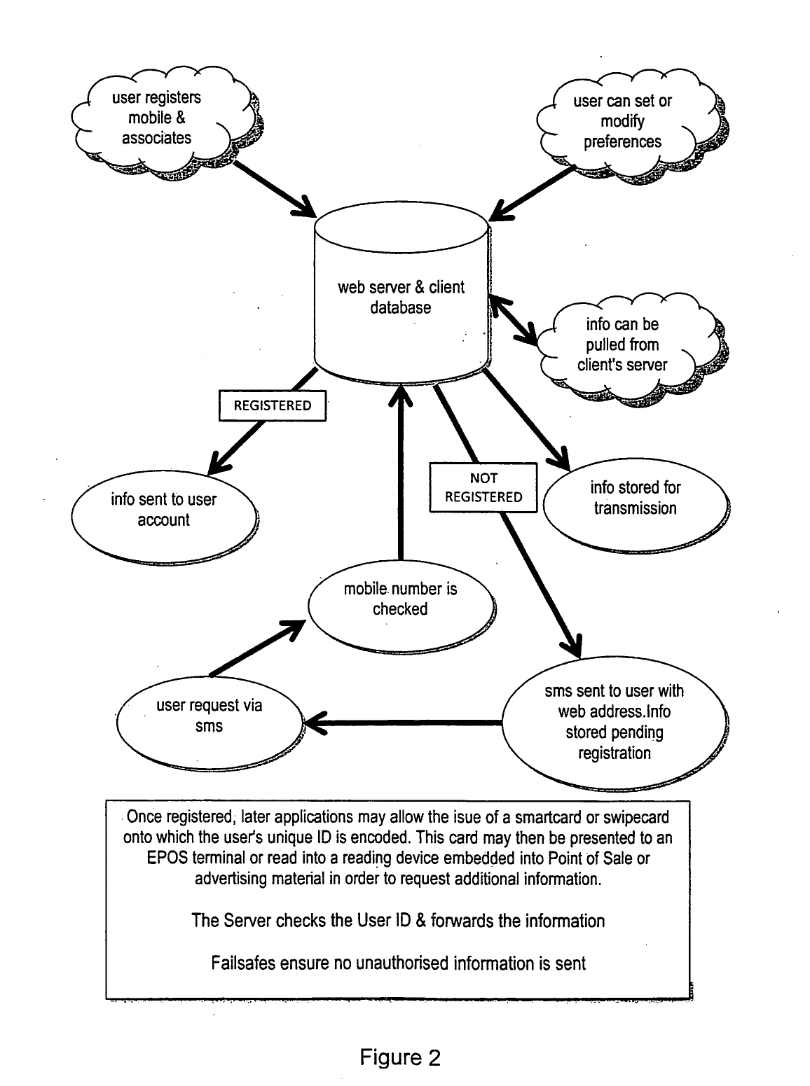

FIG. 2 shows a block diagram of an alternative system according to the present invention.

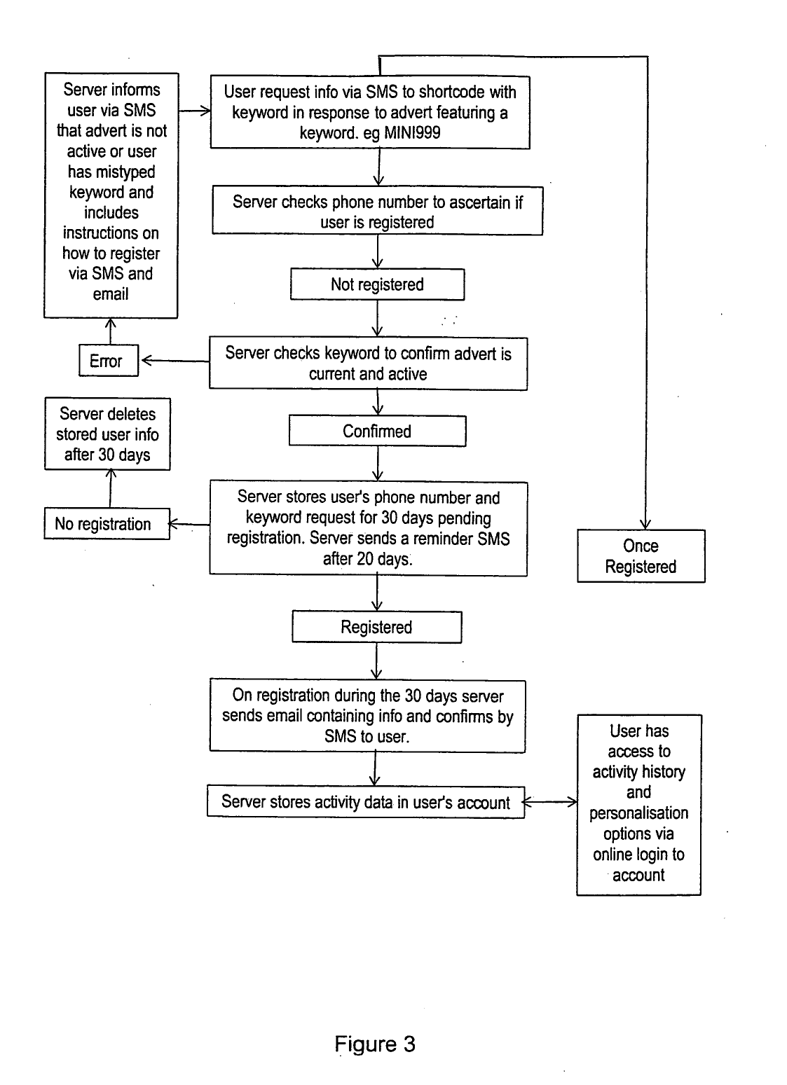

FIG. 3 shows a flowchart of a method for a user not registered with the system according to the present invention.

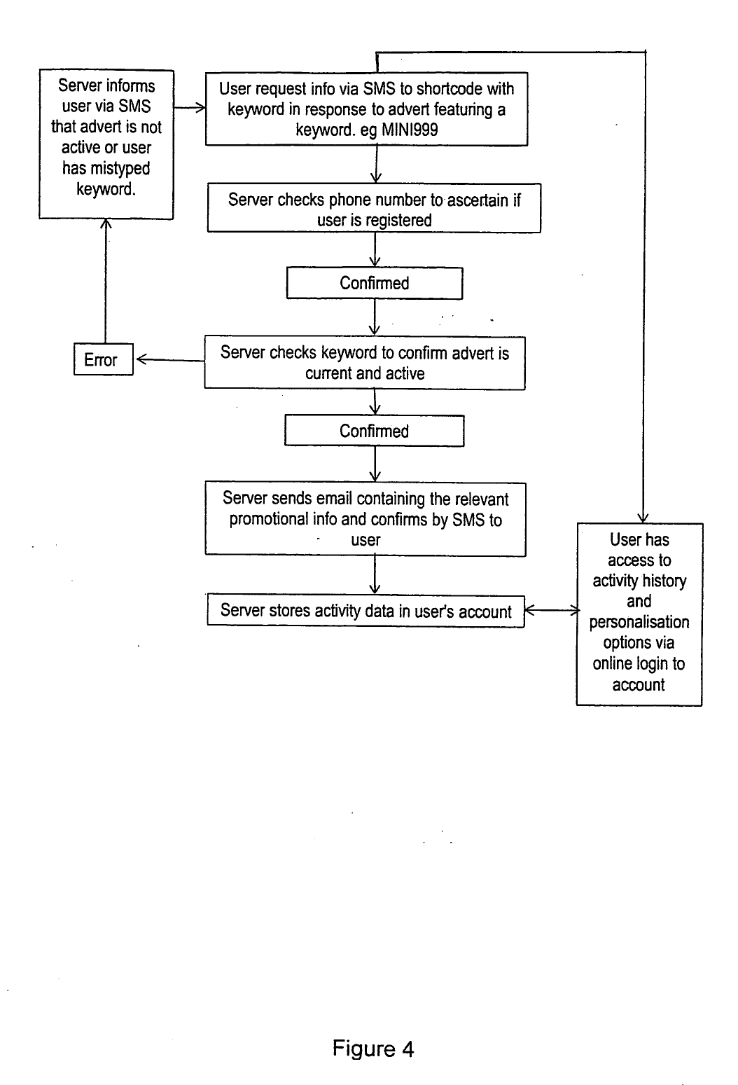

FIG. 4 shows a flowchart of a method for a user already registered with the system according to the present invention.

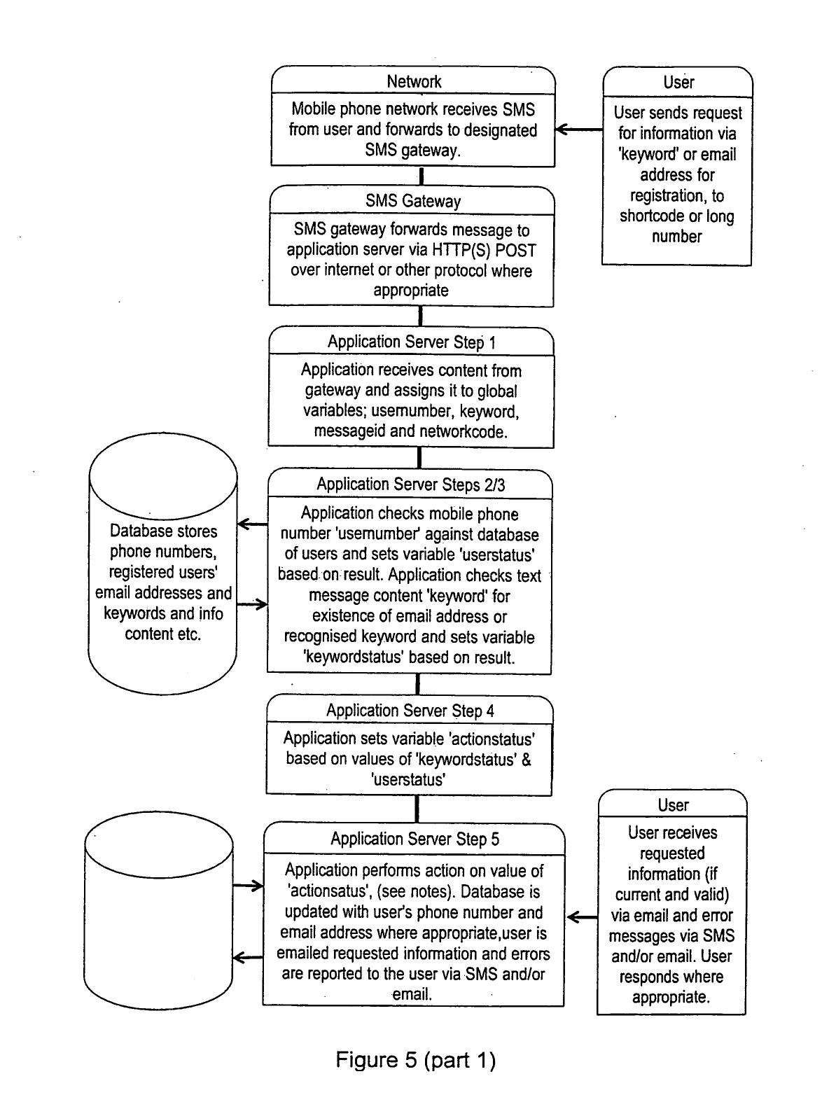

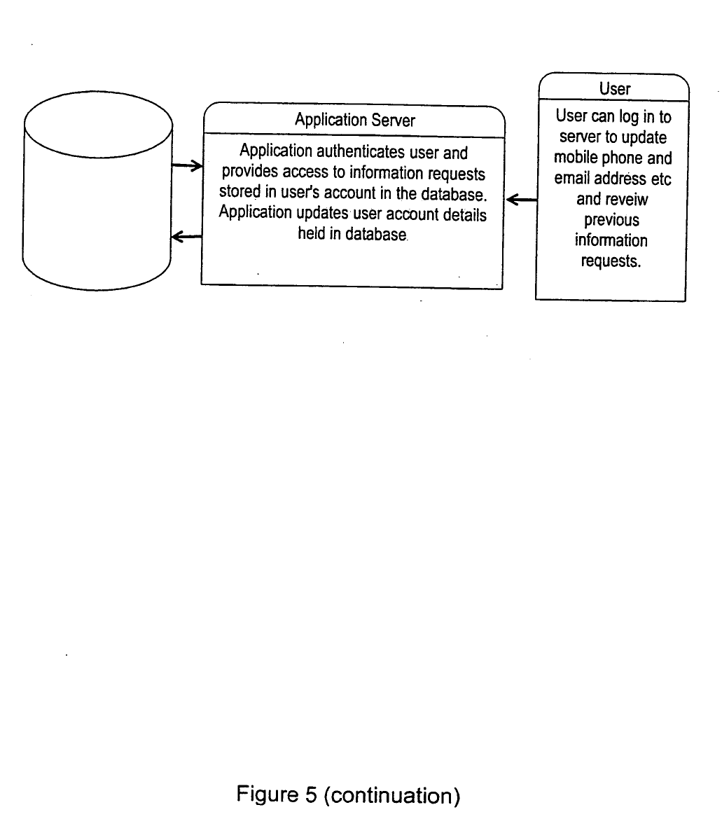

FIG. 5 shows a flowchart of an alternative method according to the present invention.

FIG. 1 depicts a flowchart, which illustrates the steps involved in delivering the information to the end user.

The user is issued with a plastic card, key fob or other storage device onto which the user's unique email id has been encoded or the email ID may be encoded onto an existing credit, debit or store cards. This may be in the form of a smart chip, barcode or magnetic strip or other means which may facilitate the transmission of this unique email ID to the retailer, manufacturer, advertising or marketing agency, wholesaler or supplier (hereafter referred to a the ‘supplier’). It is also possible to commit to memory the unique email ID and communicate this verbally.

When the user makes a purchase or simply request from a participating supplier, they present their plastic card or other storage device to the supplier and the unique email ID is read into the supplier's electronic point of sale terminal. (FIG. 1-Box A)

The user is then given the choice of receiving information from a range of options offered by the supplier; these could be an electronic receipt, information on extended warranties, information on using the product or service or information on complementary products and services or consumables and spares. The encoded email ID together with the various requests for information can then be sent to the service provider's server (hereafter referred to as the ‘server’) electronically (FIG. 1-Box E or F).

The Client Database of the Server (FIG. 1-Box I) authenticates the information received and if validated will forward the information to the client mailbox (J).

If the Client Database of the Server (FIG. 1-Box I) does not authenticate the information, a short electronic message is sent to the client mailbox (FIG. 1-Box J) inviting the user to accept or decline the mail. If the user declines to receive the mail a rejection message is sent to the retailer (FIG. 1-Box L).

The user is able to access the client mailbox (FIG. 1-Box J) via the Internet, which enables him to either access the information (FIG. 1-Box M) on the client mailbox or set his options (FIG. 1-Box N) to have any e-mails forwarded to his regular e-mail address. Additional storage space may be purchased on the client mailbox (FIG. 1-Box J) to store the information received or the information can be downloaded onto the users own hard drive.

In addition to offering information from a range of options, download devices may be incorporated into advertising or point of sale material which allow the user to request additional information on the product or service being advertised without the assistance of a cashier. (FIG. 1-Box B)

The server is also equipped to receive sms text message requests for information. The user has previously associated their mobile telephone number with their unique user email ID. (FIG. 1-Box D) The server marries requests carrying mobile telephone numbers with email ID's. (FIG. 1-Box G) The delivery of information is then authorised by the server and the information is prepared and forwarded in the same manner as if the email ID had been transmitted via the plastic card or other storage device; (FIG. 1-Box F) except in the case of the sms option the service provider prepares the final information as the retailer does not have access to the user's mobile telephone number.

The supplier has two main options regarding the information compilation. They either send raw data to be compiled automatically by the service provider (FIG. 1-Box F) or they personally prepare the final mail on their own server before delivery to the server (FIG. 1-Box E). This service can be offered as the system is ‘rolled-out’ commercially.

FIG. 2 shows an alternative, database-centric view of the system. Simplified versions of the registered and not registered methods are shown. FIG. 3 shows a method for a user not already registered with the system. FIG. 4 shows a related method for a user already registered with the system.

FIG. 5 shows an alternative, overall method incorporating both not registered and registered parts. This example relates to a system according to a further embodiment of the invention.

No doubt many other effective alternatives will occur to the skilled person. Whereas the present invention has been described with respect to specific embodiments thereof, it will be understood that the invention is not limited to the described embodiments and encompasses modifications apparent to those skilled in the art lying within the spirit and scope of the claims appended hereto.

1-30. (canceled)

31. A method of sending information corresponding to a keyword request from a user of an e-mail identification system to an e-mail address of said user, said user having a telecommunications device, said user not already registered with the system, the method comprising:
receiving a Short Message Service (SMS) message sent by said user to a system telephone number using said telecommunications device, said SMS message including a keyword and a user telephone number of said telecommunications device;
looking up said user telephone number in a database to determine whether said user is already registered with the system, and, if said user is not already registered:
looking up said keyword in said database to determine whether said keyword is active, and, if said keyword is active:
storing said user telephone number and said keyword in said database for a predetermined length of time;
sending an SMS message including information concerning how to register with the system to said user telephone number;
receiving, within said predetermined length of time, registration information comprising an e-mail address of said user sent by said user to a web server using a web browser, and storing said e-mail address corresponding to said user telephone number in said database;
retrieving keyword information corresponding to said keyword from said database; and
sending an e-mail message including said keyword information to said e-mail address of said user.

32. A method according to claim 31, the method further comprising, if said keyword is not active:
sending an SMS message including information to inform said user that said keyword is not active to said user telephone number.

33. A method according to claim 31, the method further comprising, if said registration information is not received within a second, shorter predetermined length of time, sending an SMS message including information to remind said user how to register with the system to said user telephone number.

34. A method according to claim 31, the method further comprising storing activity data corresponding to said keyword and said user telephone number and/or said e-mail address in said database, and retrieving said activity data responsive to receiving a request for said activity data from said user.

35. A computer readable medium carrying computer program code to control a processor, when running, to carry out the method of claim 31.

36. A method of sending information corresponding to a keyword to an e-mail address of a user of an e-mail identification system already registered with the system, said user having a telecommunications device, the method comprising:
receiving a Short Message Service (SMS) message sent by said user to a system telephone number using said telecommunications device, said SMS message including a keyword and a user telephone number of said telecommunications device;
looking up said user telephone number in a database to determine whether said user is already registered with the system, and, if said user is already registered:
looking up said keyword in said database to determine whether said keyword is active, and, if said keyword is active:
retrieving keyword information corresponding to said keyword from said database;
retrieving an e-mail address of said user corresponding to said user telephone number from said database; and
sending an e-mail message including said keyword information to said e-mail address of said user.

37. A method according to claim 36, the method further comprising storing information requested for retrieval via a web interface.

38. A computer readable medium carrying computer program code to control a processor, when running, to carry out the method of claim 36.

39. An e-mail identification system for sending information corresponding to a keyword to an e-mail address of a user, said user having a telecommunications device, the system comprising:
a database storing a plurality of keywords, keyword information corresponding to said plurality of keywords, a plurality of user telephone numbers corresponding to a plurality of users, and a plurality of e-mail addresses corresponding to said plurality of users;
a processor coupled to a communications interface for communicating with said database and with a mobile communications network, the processor being further coupled to a memory storing instructions for controlling the processor, when running, to carry out instructions to:
receive, from said mobile communications network, a Short Message Service (SMS) message sent by said user to a system telephone number using said telecommunications device, said SMS message including a keyword and a user telephone number of said telecommunications device;
look up said user telephone number in a database to retrieve an e-mail address of said user corresponding to said user telephone number;
look up said keyword and said user telephone number in said database to retrieve keyword information corresponding to said keyword; and
send an e-mail message including said keyword information to said e-mail address of said user.

40. A method of associating an email address to a unique ID number including:
i) associating a mobile/or land line phone with SMS facilities with an email account; or
ii) associating a mobile or land line phone with SMS facilities with a unique on line ID for retrieval via web interface; or
iii) accessing emails with the use of said unique ID number; or
iv) associating a mobile phone telephone number to said unique ID number via an SMS text message.

41. A token carrying identification information corresponding to a telephone number of a telecommunications device of a user and an e-mail address of said user, associating said email address to a unique ID number.

42. A token as claimed in claim 41 wherein said token is a plastic card of same dimensions as a standard credit card incorporating a smart chip onto which is encoded said Email ID.

43. A token as claimed in claim 42 incorporating a magnetic strip onto which is encoded said Email ID or incorporating a barcode onto which is encoded said Email ID.

44. A token as claimed in claim 41 wherein said token is a key fob incorporating a smart chip onto which is encoded said Email ID.

45. A token as claimed in claim 44 incorporating a magnetic strip onto which is encoded said Email ID or incorporating a barcode onto which is encoded said Email ID.

46. A token as claimed in claim 41 wherein said token is a portable storage medium incorporating a smart chip onto which is encoded said Email ID.

47. A token as claimed in claim 46 incorporating a magnetic strip onto which is encoded said Email ID or incorporating a barcode onto which is encoded said Email ID.

48. A token as claimed in claim 41 wherein said token is a standard debit or credit card issued by a financial institution which contains an encoded said Email ID within its smart chip or which contains an encoded said Email ID within its magnetic strip.

49. A token as claimed in claim 41 wherein said token is a loyalty card issued by a retailer or other issuer which contains an encoded said Email ID within its smart chip or which contains an encoded said Email ID within its magnetic strip or which contains an encoded said Email ID within its barcode.
